(19) United States
(12) Patent Application Publication
(10) Pub. No.: US 2007/0083867 A1
(43) Pub. Date: Apr. 12, 2007

(54) Method and system to recover from control block hangs in a heterogenous multiprocessor environment

(75) Inventors: Scott E. Davies, Kingston, NY (US); Janet R. Easton, Woodstock, NY (US); Kenneth J. Oakes, Wappingers Falls, NY (US); Andrew W. Piechowski, Lagrangeville, NY (US); Martin Taubert, Gaertringen (DE); John S. Trotter, Pleasant Valley, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/223,877

(22) Filed: Sep. 9, 2005

(51) Int. Cl. G06F 9/46

(52) U.S. Cl. 718/104

(57) ABSTRACT

Disclosed are a method and system that use state tracking constructs along with additional constructs to identify and recover control blocks inadvertently left locked that caused a hang condition in a multi-processing computing system. The preferred embodiment of the invention uses a task control blocks (TCBs) for processing units (PUs) undergoing channel subsystem (CSS) recovery. (Recovering TCBs for Recovering PUs).

### CROSS REFERENCE TO RELATED APPLICATIONS

This application is related to copending application no. (Attorney Docket POU920050087US1), for “Method And System To Execute Recovery In Non-Homogeneous Multiprocessor Environments,” filed herewith; application no. (Attorney Docket POU920050088US1), for “Method And System To Detect Errors In Computer Systems By Using State Tracking,” filed herewith; and application no. (Attorney Docket POU920050096US1), for “Method And System For State Tracking And Recovery In MultiProcessing Computing Systems,” filed herewith. The disclosures of the above-identified applications are herein incorporated by reference in their entireties.

### BACKGROUND OF THE INVENTION

1. Field of the Invention

This invention in general relates to computer systems, and in particular to multiprocessor systems. Even more specifically, the invention relates to recovery procedures used in multi-processing computing systems.

2. Background Art

Multiprocessor computer systems are becoming increasingly important in modern computing because combining multiple processors increases processing bandwidth and generally improves throughput, reliability and serviceability. Multiprocessing computing systems perform individual tasks using a plurality of processing elements, which may comprise multiple individual processors linked in a network, or a plurality of software processes or threads operating concurrently in a coordinated environment.

Many early multiprocessor systems were comprised of multiple, individual computer systems, referred to as partitioned systems. More recently, multiprocessor systems have been formed from one or more computer systems that are logically partitioned to behave as multiple independent computer systems. For example, a single system having eight processors might be configured to treat each of the eight processors (or multiple groups of one or more processors) as a separate system for processing purposes. Each of these “virtual” systems would have its own copy of an operating system, and may then be independently assigned tasks, or may operate together as a processing cluster, which provides for both high speed processing and improved reliability.

The International Business Machines Corporation zSeries servers have achieved widespread commercial success in multiprocessing computer systems. These servers provide the performance, scalability, and reliability required in “mission critical environments.” These servers run corporate applications, such as enterprise resource planning (ERP), business intelligence (BI), and high performance e-business infrastructures. Proper operation of these systems can be critical to the operation of an organization and it is therefore of the highest importance that they operate efficiently and as error-free as possible, and rapid problem analysis and recovery from system errors is vital.

In IBM zSeries servers, a major advantage of the servers' is the mainframes' ability to recover from many classes of detected errors which subscribe to the platform's high standard for system availability. The basic concept of channel subsystem (CSS) Recovery that was developed in the early mainframes was for recovery to restore a shared resource to a known state should a hardware element take a failure while using that resource.

In normal operation, a partitioned system operates in parallel, that is, the operations being performed by the partitions can occur simultaneously as the partitions share the operational resources of the server. With everything functioning properly, the various partitions, which may be operating using different operating system, perform their functions simultaneously.

There are certain critical functions, however, that require serialization of the system for a short period of time. Serialization is the forcing of operations to occur in a serial, rather than parallel, fashion, even when the operations could be performed in parallel. Serialization is typically mandatory when the correctness of the computation depends upon or might depend upon the exact order of computation, or when an operation requires uninterrupted use of otherwise shared hardware resources (e.g., I/O resources) for a brief time period.

An example of shared resources within the zSeries CSS used by processor hardware elements (PU) operating, as either I/O Processors (IOP) or central processors (CP) to manage various I/O tasks are internal data structures known as controls blocks. These control blocks reside in hardware system area (HSA) which is memory accessible to firmware. Not all control blocks are shared, but examples of those that are shared are the subchannels (SCB). An SCB is a logical representation of a device. There are millions of SCBs in HSA to manage I/O tasks for devices connected to a zSeries server.

A control block is considered shared if its state can be altered by one or more PUs in a multiprocessor environment (MP) or by different tasks running in the different modes on the same PU. Serialization of state is maintained via locks. In the course of processing tasks in the system, one or more of these shared control blocks are acquired (locked) by a PU usually at the beginning of a task. When a PU has a control block locked, it is viewed as the exclusive owner of the control block and can modify the control block state as required by the task. Should another PU need that same control block for a task it is performing, this new requester would typically spin in a code loop trying to lock the control block. Upon completion of the task, the PU holding the lock will release (unlock) that control block thereby allowing this new requestor to acquire this control block. By completion of the task, all control blocks locked by that PU should be unlocked.

Should a PU fail by taking a hardware error after locking a control block, but before unlocking it, other PUs that need that control block, would likely just spin until CSS Recovery restored that control block to known and unlocked state. CSS Recovery is a firmware task that is dispatched to an operational IOP to recover CSS resources if one or more of the failing elements are capable of accessing CSS resources. Since all PUs have access to CSS shared control blocks, CSS Recovery would be dispatched for this failing PU. The CSS Recovery method currently employed by the zSeries CSS for a PU failure is to perform a “scan” or “rummage” recovery. This is essentially an examination of all the I/O control blocks built in HSA for the configuration looking for control blocks that are exclusively owned or locked by the failing PU. CSS Recovery makes use of the fact that the identity of the locking PU is set into the lock owner portion of the lock word when the control block is locked. Once in a known and unlocked state, the PU attempting to lock the control block would be able to lock and update it to perform its required I/O task. Without CSS Recovery, hardware failures as described above would cause other, perfectly healthy PUs to hang-spinning for a long time waiting for the prior lock owner to unlock the control block.

CSS Recovery works very well for recovering control blocks left locked by a PU that failed due to a hardware error. This is because the identity of the locking element is set into the lock owner portion of the lock word when the control block is locked. This allows CSS Recovery to know which control blocks to recover and unlock.

The situation may be different, however, if a control block was locked by a PU and a firmware bug caused the PU not to unlock it. Usually, the PU that left the control block locked is typically healthy from a hardware viewpoint that is, no error indicators came on indicating anything was wrong with that processor. But for the unsuspecting PU that is attempting to lock the control block, it will spin and eventually hang.

Most tasks within the zSeries CSS are timed so that if a PU has hung, the task will be timed out. On timeouts, the recovery action used today has been to schedule CSS Recovery for the PU that timed out. This would recover control blocks locked already by that PU as part of the task. However, the control block left locked by the PU who forgot to unlock it would not be recovered by the current CSS Recovery method as mentioned above. Other PUs could also eventually timeout attempting to lock this control block, perhaps multiple times causing multiple invocations of CSS recovery for those PUs. If a PU is taken through recovery multiple times within a certain period of time, there is a recovery escalation of the PU to a check stopped state which is essentially fencing off the PU making it unusable. A system IML would then be required to attempt to restore that PU into the configuration. Unfortunately, if enough PUs are check stopped there will be none left and the entire system would be made unusable and be put in the system checkstop state which is also known as a UIRA—unscheduled incident repair action.

### SUMMARY OF THE INVENTION

An object of the present invention is to improve recovery procedures in multi-processing computing systems.

Another object of this invention is to identify and recover control blocks inadvertently left locked by an otherwise healthy processing unit without forcing that processing unit through recovery.

A further object of the invention is to use state tracking constructs to identify and recover control blocks inadvertently left locked in a multiprocessing computing system.

These and other objectives are attained in accordance with the present invention by use of state tracking constructs along with additional constructs to identify and recover control blocks inadvertently left locked that caused a hang condition in a multi-processing computing system. These state tracking constructs are also discussed in the above-identified co-pending Application No. (Attorney Docket No. POU920050096US1) for “Method and System for State Tracking and Recovery in Multi-Processing Computing Systems.”

The preferred embodiment of the invention, described below in detail, uses the following infrastructure features:
Task control blocks (TCBs) for processing units (PUs) undergoing channel subsystem (CSS) recovery. (Recovering TCBs for Recovering PUs).
   Lock Words of control blocks pointed to by control block entries in the Recovering TCBs
   TCBs for PUs that will be undergoing CSS Recovery “Other” TCBs for “Other” PUs)
   TCBs for PUs not being recovered (TCBs of Operational PUs)

This enables CSS Recovery to determine if a PU that locked a control block (control block owner) potentially causing a control block hang has some initiative to unlock the control block. If it is determined that the initiative to unlock a control block has been lost by the control block owner, the control block will be recovered and unlocked. The initiative to unlock a control block is ensured if a locked control block is in the TCB of the PU that locked it. This may be done, for example, using the method disclosed in the above-identified co-pending Application No. (Attorney Docket No. POU920050088US1) for “Method and System to Detect Errors In Computer Systems Using State Tracking.”

This invention also discloses a method for recovering individual control blocks that are hung without disturbing Operational PUs that inadvertently left control blocks locked. This is accomplished by “stealing” the lock.

Also, disclosed herein is a method to determine if a consistent state exists between a control block lock and the TCB for an Operational PU. An Operational PU may be in the process of unlocking and perhaps re-locking the control block for valid reasons and changing its TCB state. This control block may have appeared in the Recovering TCB as the potential cause of a Hang. This method enables Hang Recovery to make the judgment as to whether or not this control block has been inadvertently left locked or in transition so the proper recovery actions can be taken.

The methods disclosed for hang recovery have also been tailored to fit within the parallel recovery paradigm as disclosed in the above-identified co-pending Application No. (Attorney Docket No POU920050087US1) for “Method and System to Execute Recovery In Non-Homogeneous Multiprocessor Environments.” Hang Recovery can be going on under different CSS Recovery Tasks in parallel.

The preferred embodiment of the invention provides a number of important advantages. For example, the invention provides a method to recover from hung control blocks due to firmware errors. In this way, the invention is able to prevent or to fix a class of UIRAs that had been caused by those hung control blocks. Further, the present invention is able to recover control blocks inadvertently left locked by an otherwise healthy PU without forcing that PU through recovery. This solution is much less costly in terms of code complexity and overhead.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a multi-processing computing system with which the present invention may be used.

FIG. 2 shows task control blocks that may be used in this invention.

FIG. 3 is a table showing hang recovery actions that may be invoked in the operation of the present invention.

FIG. 4 is a table showing hang recovery actions for operational processing units.

FIG. 5 illustrates a preferred lock word of a control block.

FIG. 6 is a flow chart showing a preferred procedure for determining if a lock word is in transition.

### DETAILED DESCRIPTION OF THE PREFERRED EMBODIMENT

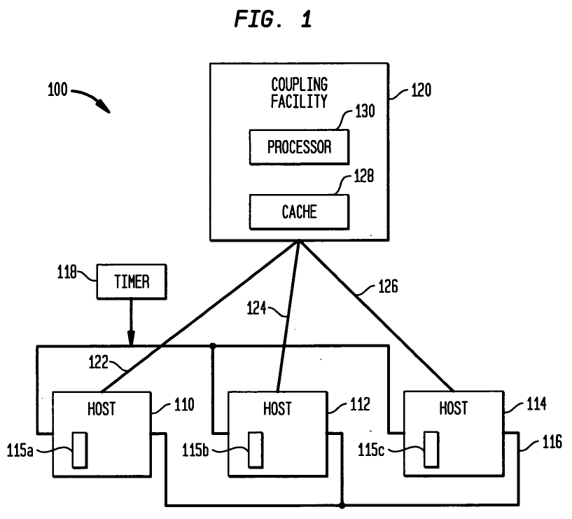

FIG. 1 illustrates multiprocessor computer system 100 that generally comprises a plurality of host computers 110, 112, 114, which are also called “hosts”. The hosts 110, 112, 114 are interconnected with host links 116, which may comprise, for example, Coupling Links, Internal Coupling Channels, an Integrated Cluster Bus, or other suitable links. Rather than using three hosts 110, 112, 114 as in the illustrated example, in alternative embodiments one, two, four, or more hosts may be used. System 100 also includes a timer 118 and a coupling facility 120.

Each host 110, 112, 114 itself is a multiprocessor system. Each host 110, 112, 114 may be implemented with the same type of digital processing unit (or not). In one specific example, the hosts 110, 112, 114 each comprise an IBM zSeries Parallel Sysplex server, such as a zSeries 900, running one or more of the z Operating System (z/OS). Another example of a suitable digital processing unit is an IBM S/390 server running OS/390. The hosts 110, 112, 114 run one or more application programs that generate data objects, which are stored external from or internal to one or more of the hosts 110, 112, 114. The data objects may comprise new data or updates to old data. The host application programs may include, for example, IMS and DB2. The hosts 110, 112, 114, run software that includes respective I/O routines 115a, 115b, 115c. It may be noted that other types of hosts may be used in system 100. In particular, hosts may comprise any suitable digital processing unit, for example, a mainframe computer, computer workstation, server computer, personal computer, supercomputer, microprocessor, or other suitable machine.

The system 100 also includes a timer 118 that is coupled to each of the hosts 110, 112, 114, to synchronize the timing of the hosts 110, 112, 114. In one example, the timer 118 is an IBM Sysplex®. Timer. Alternatively, a separate timer 118 may be omitted, in which case a timer in one of the hosts 110, 112, 114 is used to synchronize the timing of the hosts 110, 112, 114.

Coupling facility 120 is coupled to each of the hosts 110, 112, 114 by a respective connector 122, 124, 126. The connectors 122, 124, 126, may be, for example, Inter System Coupling (ISC), or Internal Coupling Bus (ICB) connectors. The coupling facility 120 includes a cache storage 128 “cache”) shared by the hosts 110, 112, 114, and also includes a processor 130. In one specific example, the coupling facility 120 is an IBM z900 model 100 Coupling Facility. Examples of other suitable coupling facilities include IBM model 9674 C04 and C05, and IBM model 9672 R06. Alternatively, the coupling facility 120 may be included in a server, such as one of the hosts 110, 112, 114.

As an example, some suitable servers for this alternative embodiment include IBM z900 and S/390 servers, which have an internal coupling facility or a logical partition functioning as a coupling facility. Alternatively, the coupling facility 120 may be implemented in any other suitable server. As an example, the processor 130 in the coupling facility 120 may run the z/OS. Alternatively, any suitable shared memory may be used instead of the coupling facility 120. The cache 128 is a host-level cache in that it is accessible by the hosts 110, 112, 114. The cache 128 is under the control of the hosts 110, 112, 114, and may even be included in one of the host machines if desired.

In normal operation, System 100, which is typical of a partitioned system, operates in parallel, that is, the operations being performed by the partitions can occur simultaneously as the partitions share the operational resources of the server. With everything functioning properly, the various partitions, which may be operating using different operating system, perform their functions simultaneously.

There are certain critical functions, however, that require serialization of the system for a short period of time. Serialization is the forcing of operations to occur in a serial, rather than parallel, fashion, even when the operations could be performed in parallel. Serialization is typically mandatory when the correctness of the computation depends upon or might depend upon the exact order of computation, or when an operation requires uninterrupted use of otherwise shared hardware resources (e.g., I/O resources) for a brief time period.

An example of shared resources within the zSeries CSS used by processor hardware elements (PUs) operating as either I/O Processors (IOPs) or central processor (CPs) to manage various I/O tasks are internal data structures known as control blocks. These control blocks reside in hardware systems area (HSA), which is memory accessible to firmware.

In the course of processing tasks in the system, one or more of these shared control blocks are acquired (locked) by a PU usually at the beginning of a task. Should another Pu need that same control block for a task it is performing, this new requestor would typically spin in a code loop trying to lock the control block. Upon completion of the task, the PU holding the lock will release (unlock) that control block, thereby allowing this new requestor to acquire this control block. By completion of the task, all control blocks locked by that Pu should be unlocked.

Situations can arise, however, where a control block was locked by a PU and a firmware bug caused the PU not to unlock the control block. Usually, the PU that left the control block locked is typically healthy from a hardware viewpoint—that is, no error indicators came on indicating anything was wrong with the processor. But for the unsuspecting PU that is attempting to lock the control block, it will spin for a long time and eventually hang.

The present invention effectively addresses this situation. In the preferred embodiment of the invention, this is accomplished by use of the following infrastructure features:
Task control blocks (TCBs) for processing units (PUs) undergoing channel subsystem (CSS) recovery. (Recovering TCBs for Recovering PUs).
   Lock Words of control blocks pointed to by control block entries in the Recovering TCBs
   TCBs for PUs that will be undergoing CSS Recovery “Other” TCBs for “Other” PUs)
   TCBs for PUs not being recovered (TCBs of Operational PUs)

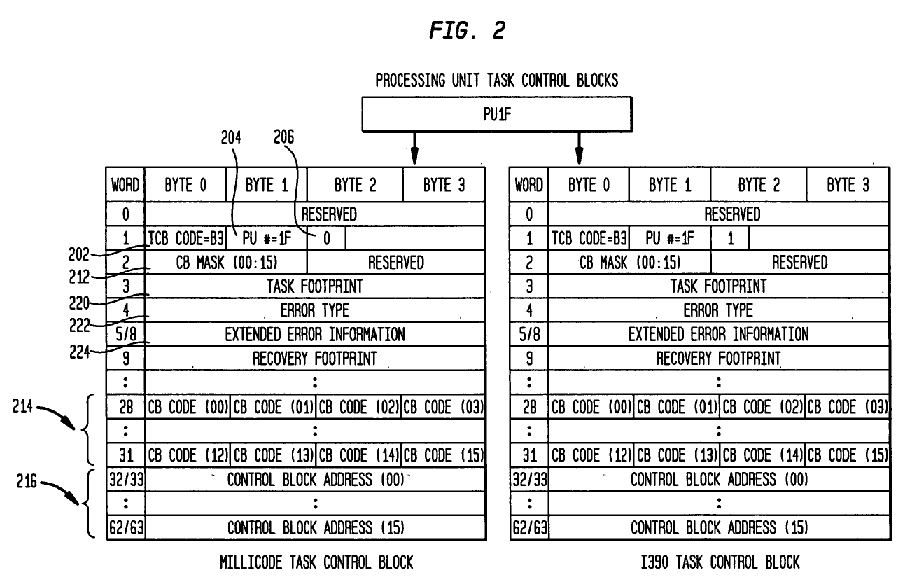

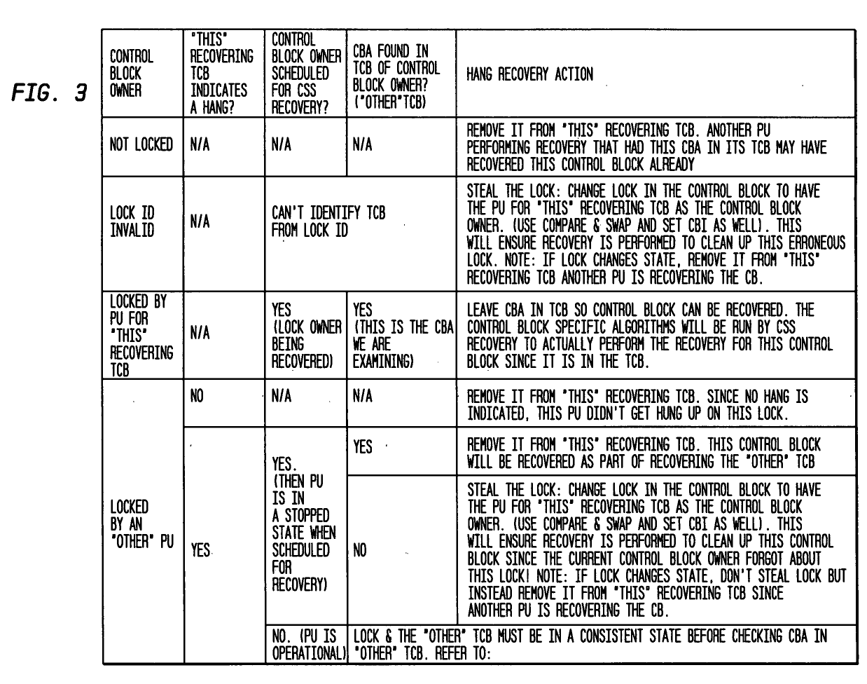

FIG. 2 illustrates a task control block in more detail. Generally, Task Control Blocks (TCB) are used to record which I/O control blocks are in use by each PU. Each PU is preferably assigned 2 TCBs to support the dual operation modes of the PU, i390 mode and millicode mode.

The infrastructure described herein is preferably used in mainline I/O code as well as the I/O Subsystem Recovery code.

More specifically, the TCB will contain information about:
The control blocks being used, locked or attempted to be locked by a PU while executing an I/O task.
PU task state footprint information.
If an error occurs the PU will store error type, error code, and extended error information in the TCB.

Each task running on the PU is assigned a TCB. For example, on the IBM zSeries servers, the PUs can execute in 2 modes, i390 mode or Millicode mode, thus when the present invention is implemented with such servers, there preferably will be 2 TCBs allocated for each. PU. Defining unique TCBs per PU for I390 mode and Millicode mode allows greater interleaving of tasks that can occur when processors switch modes while processing functions by keeping the resources used separated. This structure is shown in FIG. 2.

Key TCB Field Definitions

1. TCB Code field 202: Unique static hexadecimal value to identify TCB control block type.

2. PU# field 204: Physical PU number owning the TCB.

3. Mode field 206: Identifier for Millicode or I390 mode

4. Control Block Slot Arrays: Three 16 element arrays that contain:
Control Block Mask (CBM) Array 212: Indicates that a Control block was locked or in the process of being locked.
Control Block Code (CBC) Array 214: Contains Control Block Code of the Control Block that was locked or being locked.
Control Block Address (CBA) Array 216: Contains Control Block Address of the Control Blocks that was lock or being locked.

5. Task Footprint field 220: Indicator of current task step executing on the PU

6. Error Code field 222: Unique Error data stored by failing task.

7. Extended Error Information field 224: Additional data stored by failing task to aid in recovery or problem debug.

The first step in processing a Hang is detection of it. If a hang had been detected by a hang detection process such as, for example, the i390 Watchdog Timer task or by the millicode control block locking task that directly times a control block locking process, that information would be passed in the TCB in the Error Code field. When the Hang Recovery function needs to determine if the PU is “Hung”, it can examine the Error Code field in the TCB. In the current embodiment, these two Error Types are treated as Hangs:
Error Type 04: Watchdog timeout (i390)
Error Type 31: Millicode Hang Summary

Hangs, when detected, is one class of error that will result in CSS Recovery to be dispatched. In this embodiment, CSS Recovery is performed by one or more IOPs and the new Hang Recovery function is invoked anytime CSS Recovery is dispatched to actually do the checking to see if the reason for invocation is for a Hang. Hang Recovery will be invoked after the TCBs for the recovering. PUs are validated, but before CSS Recovery invokes the control block specific algorithms to recover the control blocks left in the TCBs.

For each PU being recovered by CSS Recovery, which could be either an IOP or CP, Hang Recovery will step through the control block entries in both the millicode and i390 TCBs of each PU being recovered and examine the Lock Word in the control block pointed to by each valid CBA. It would then perform the appropriate action based on Table 1 of FIG. 3 —Hang Recovery Algorithm based on Lock Word, “This” Recovering TCB and “Other” TCBs. Hang Recovery will also “scrub” the Recovering TCB as indicated in this table even though the Hang Indicators do not indicate a Hang existed.

Determining Lock Transition State and CBA Existence in a TCB for an Operational PU

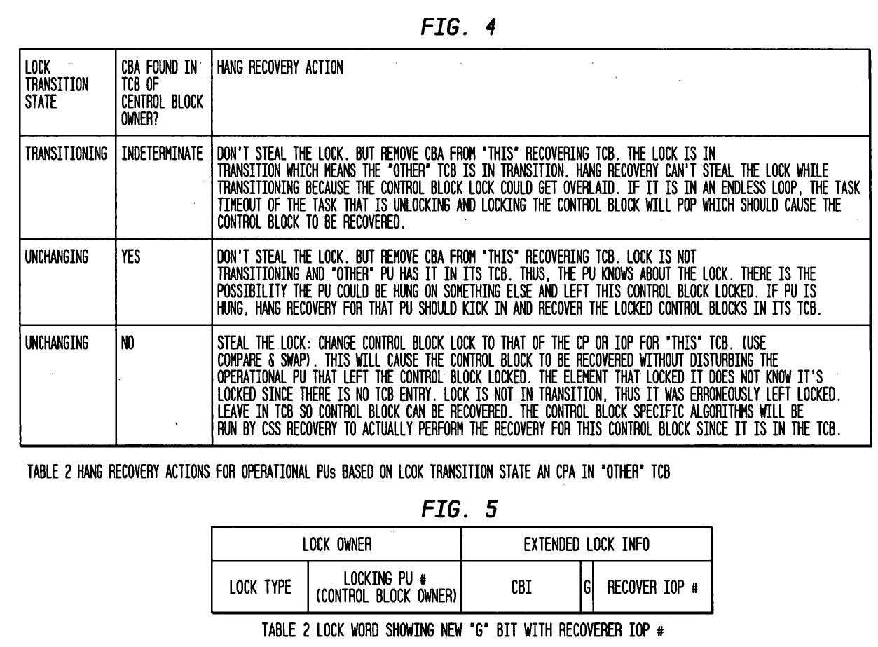

Table II in FIG. 4 describes the hang recovery actions that will be taken based on the novel lock transition determination method described below.

New Constructs Added to Lock Word

The following new constructs, illustrated in FIG. 5, are included in the Lock Word for determining if the Lock Word is in Transition, as described below.
“G’bit, and
Recoverer IOP#.
   Procedure for determining if the Lock Word is in Transition

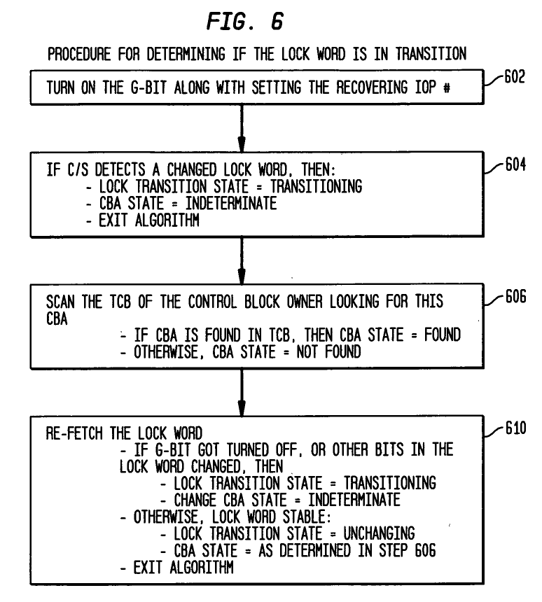

In order to determine if the TCB of an operational PU can be examined to find a CPA of a potentially hung control block, the lock and TCB of the control block owner must be in a consistent state. Described below, and generally illustrated in FIG. 6, is a method which makes use of the New Constructs Added to Lock Word to determine Lock Word and TCB state:

At step 602, atomically turn on the G-bit along with setting Recoverer IOP# (IOP running CSS Recovery) using a Compare and Swap Instruction (C/S) into the Lock Word of the potentially hung control block.

At step 604, if C/S detects a changed lock word, then:
Lock Transition State=“Transitioning”
CBA State=“Indeterminate”
Exit algorithm

At step 606, scan the TCB of the Control Block Owner looking for this CBA:
If CBA is found in TCB,
   CBA State=“FOUND”
Otherwise,
   CBA State=“NOT Found”

At step 610, re-fetch the lock word
If G-bit got turned off, or other bits in the Lock Word changed (i.e., Recoverer IOP #, etc . . . )
   Lock Transition State=“Transitioning”
   Change CBA State=“Indeterminate”
Otherwise, Lock Word stable:
   Lock Transition State=“Unchanging”
   CBA State=as determined in Step 606
   Exit algorithm
      Parallel Recovery Considerations for Hang Recovery

The reason for the Recoverer IOP # in FIG. 5, Table 3 is to help detect if another IOP performing CSS Recovery in Parallel is also setting the G-bit. This closes a window introduced by Parallel Recovery whereby the G-bit is set ON by IOP “A”; the Operational PU turns turning it OFF, which is OK; Then IOP “B” turns it back ON; IOP “A” then may see it on and take the wrong action. Now this can be detected via a change in the Recoverer IOP #.

In addition, the methods for Hang Recovery in Table 1 and 2 were designed with Parallel recovery in mind. With the TCBs organized on a PU basis and containing control blocks either locked or attempting to be locked by that PU, lends itself to the Parallel CSS Recovery paradigm of having an IOP perform CSS Recovery for a set of PUs that do not overlap with another set of PUs undergoing CSS Recovery thereby avoiding recovering the same control blocks by different CSS Recoveries in parallel.

Hang Recovery resolves any TCB control block overlap by removing control blocks from the Recovering TCB that are not locked by the PU it is currently recovering after ensuring that the locked control blocks were in the correct TCBs. Also, to avoid interfering with other CSS Recovery tasks in parallel, the algorithms for Table 1 and 2 were designed to only make modifications to the currently Recovering TCBs rather than making modifications to other TCBs it was not recovering for—it would “steal” the lock if need be rather than insert the missing CBA in the TCB for the control block owner. This also avoids having to lock TCBs.

The preferred embodiment of the invention provides a number of important advantages. For example, the invention provides a method to recover from hung control blocks due to firmware errors. In this way, the invention is able to prevent or to fix a class of UIRAs that had been caused by those hung control blocks. Further, the present invention is able to recover control blocks inadvertently left locked by an otherwise healthy PU without forcing that PU through recovery. This solution is much less costly in terms of code complexity and overhead.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of recovering from control block hangs in a multiprocessor system including a plurality of processing units, a plurality of I/O control blocks, and a plurality of task control blocks, the method comprising the steps of:
assigning one of the task control blocks to each of the processing units;
locking I/O control blocks for exclusive use by individual ones of the processing units;
identifying in the task control blocks assigned to the processing units, the I/O control blocks locked for the processing units;
using one of the task control blocks to indicate that one of the I/O control blocks that was previously locked by the processing unit to which said one of the task control block is assigned, has remained locked in error;
invoking a recovery procedure; and
using said recovery procedure to unlock said previously locked one of the I/O control blocks.

2. A method according to claim 1, wherein the step of using one of the task control blocks includes the steps of:
determining that said one of the I/O control blocks has remained locked in error;
identifying the task control block assigned to the processing unit that had locked said one of the I/O control blocks; and
adding information to said identified task control block indicating that said one of the I/O control blocks has remained locked in error.

3. A method according to claim 2, wherein the step of using said recovery procedure includes the steps of using said recovery procedure to examine said identified task control block for said information, and then to unlock said previously locked one of the I/O control blocks.

4. A method according to claim 1, wherein each of the I/O control blocks includes a lock word, and the step of using said recovery procedure includes the steps of:
using one of the processing units to perform said recovery procedure; and
identifying said one of the processing units in said one of the I/O control blocks.

5. A method according to claim 4, wherein the step of using said recovery procedure includes the further step of setting a flag in said lock word of said one of the I/O control blocks to indicate that said lock word is in transition.

6. A recovery system for recovering from control block hangs in a multiprocessor system including a plurality of processing units, and a plurality of I/O control blocks, the recovery system comprising:
a plurality of task control blocks, wherein each of the processing units is assigned one of said task control blocks;
means for locking I/O control blocks for exclusive use by individual ones of the processing units;
means for identifying in the task control blocks assigned to the processing units, the I/O control blocks locked for the processing units;
means for using one of the task control blocks to indicate that one of the I/O control blocks that was previously locked by the processing unit to which said one of the task
control block is assigned, has remained locked in error; and
a recovery procedure to unlock said previously locked one of the I/O control blocks.

7. A recovery system according to claim 6, wherein the means for using one of the task control blocks includes:
means for determining that said one of the I/O control blocks has remained locked in error;
means for identifying the task control block assigned to the processing unit that had locked said one of the I/O control blocks; and
means for adding information to said identified task control block indicating that said one of the I/O control blocks has remained locked in error.

8. A recovery system according to claim 7, wherein said recovery procedure includes means to examine said identified task control block for said information, and then to unlock said previously locked one of the I/O control blocks.

9. A recovery system according to claim 6, wherein each of the I/O control blocks includes a lock word, and said system further includes:
means for selecting one of the processing units to perform said recovery procedure; and
means for identifying said one of the processing units in said one of the I/O control blocks.

10. A recovery system according to claim 9, wherein said recovery procedure includes means for setting a flag in said lock word of said one of the I/O control blocks to indicate that said lock word is in transition.

11. A program storage device readable by machine, tangibly embodying a program of instructions executable by the machine to perform method steps for recovering from control block hangs in a multiprocessor system including a plurality of processing units, a plurality of I/O control blocks, and a plurality of task control blocks, said method steps comprising:
assigning one of the task control blocks to each of the processing units;
locking I/O control blocks for exclusive use by individual ones of the processing units;
identifying in the task control blocks assigned to the processing units, the I/O control blocks locked for the processing units;
using one of the task control blocks to indicate that one of the I/O control blocks that was previously locked by the processing unit to which the task control block is assigned, has remained locked in error;
invoking a recovery procedure; and
using said recovery procedure to unlock said previously locked one of the I/O control blocks.

12. A program storage device according to claim 11, wherein the step of using one of the task control blocks includes the steps of:
determining that said one of the I/O control blocks has remained locked in error;
identifying the task control block assigned to the processing unit that had locked said one of the I/O control blocks; and
adding information to said identified task control block indicating that said one of the I/O control blocks has remained locked in error.

13. A program storage device according to claim 12, wherein the step of using said recovery procedure includes the steps of using said recovery procedure to examine said identified task control block for said information, and then to unlock said previously locked one of the I/O control blocks.

14. A program storage device according to claim 11, wherein each of the I/O control blocks includes a lock word, and the step of using said recovery procedure includes the steps of:
using one of the processing units to perform said recovery procedure; and
identifying said one of the processing units in said one of the I/O control blocks.

15. A program storage device according to claim 14, wherein the step of using said recovery procedure includes the further step of setting a flag in said lock word of said one of the I/O control blocks to indicate that said lock word is in transition.
